(19) United States
(12) Patent Application Publication
(10) Pub. No.: US 2022/0181934 A1
(43) Pub. Date: Jun. 9, 2022

(54) ELECTRIC MACHINE ROTOR COOLING

(71) Applicant: BAE Systems Controls Inc., Endicott, NY (US)

(72) Inventors: John P. Durkot, Binghamton, NY (US); Stephen J. Kosteva, Endicott, NY (US); Arthur P. Lyons, Maine, NY (US); Mark A. Walker, Vestal, NY (US)

(73) Assignee: BAE Systems Controls Inc., Endicott, NY (US)

(21) Appl. No.: 17/116,571

(22) Filed: Dec. 9, 2020

(51) Int. Cl. H02K 1/32; H02K 1/27; H02K 9/19

(52) U.S. Cl. CPC H02K 1/32; H02K 9/19; H02K 1/2786

(57) ABSTRACT

A rotor hub assembly includes a rotor hub, a rotor and a cooling sleeve surrounding the rotor hub and located between the rotor hub and the rotor. Coolant flows between the rotor hub and the rotor during spinning of the rotor hub assembly. The cooling sleeve may include channels formed in the inner surface. The rotor hub may include an annular channel in fluid communication with the cooling sleeve channels. The annular channel may include apertures such that the cavities in the rotor hub are in fluid communication with the cooling sleeve. Coolant circulating within the rotor hub enters the annular channel and the channels in the cooling sleeve from centrifugal force caused by spinning of the rotor hub assembly.

### BACKGROUND

The present disclosure is generally directed to electric machines and more particularly to cooling the rotor of an electric machine.

Electric machines, such as motors and generators, are used to generate mechanical power in response to an electrical input or to generate electrical power in response to a mechanical input. Electric machines are generally comprised of a stator assembly and a rotor assembly within housing. During operation of the electric machines, a considerable amount of heat energy can be generated by both the stator assembly and the rotor assembly, in addition to other components of the electric machines. Magnetic, resistive, and mechanical losses within the motors and generators during mechanical and electrical power generation cause a build up of heat, which must be dissipated to avoid malfunction and/or failure of the electric machine. One of the limitations on the power output of an electric machine is the capacity of the electric machine to dissipate this heat. Conventional cooling methods can include removing the generated heat energy by convection to a jacket filled with a coolant.

Limitations associated with some electric machines can include difficulties associated with designing insulation for some portions of the stator assembly; however, difficulties also can arise in cooling of the rotor assembly. Also, some electric machines, including interior permanent magnet electric machines, can include magnets, which can generate heat energy but can be difficult to cool. If not properly cooled, the magnets can become largely demagnetized which can lead to a decrease in electric machine productivity and lifespan.

For example, a bus traction motor design may experience rotor temperatures above material limits for the magnets. If operated at these temperatures permanent damage can occur to the magnets.

### BRIEF SUMMARY

A rotor hub assembly in one embodiment includes a rotor hub, a rotor surrounding the rotor hub comprising a plurality of rotor laminations and a plurality of magnets, and a cooling sleeve surrounding the rotor hub and being located between the rotor hub and the rotor, the cooling sleeve being configured to cause coolant to flow between the rotor hub and the rotor during spinning of the rotor hub assembly. In one embodiment, the cooling sleeve includes a plurality of channels formed in the inner surface of the cooling sleeve. In one embodiment, the plurality of channels extend laterally across the inner surface from one side to an opposite side of the cooling sleeve. In one embodiment, the plurality of channels extend over the entire circumference of the inner surface of the cooling sleeve.

In one embodiment, the rotor hub includes an annular channel that surrounds the entire circumference of an outer surface of rotor hub such that the annular channel is in fluid communication with the plurality of channels formed in the inner surface of the cooling sleeve.

In one embodiment, the rotor hub includes a plurality of apertures within the annular channel. In one embodiment, the rotor hub includes a plurality of interior cavities in fluid communication with the annular channel of the rotor hub.

In one embodiment, an end ring is attached to a side edge of the cooling sleeve, the end ring being configured to cause at least a portion of the coolant circulating within the rotor hub to enter the annular channel in the rotor hub and the plurality of channels in the cooling sleeve from centrifugal force caused by spinning of the rotor hub assembly.

In one embodiment, the rotor hub includes a plurality of notches aligned with the plurality of channels in the cooling sleeve such that coolant entering the plurality of channels in the cooling sleeve exits through the notches. In one embodiment, the end ring includes a plurality of apertures aligned with the plurality of channels in the cooling sleeve such that coolant entering the plurality of channels in the cooling sleeve exits through the plurality of apertures in the end ring.

In one embodiment a method of cooling a rotor hub assembly including a rotor hub and a rotor surrounding the rotor hub, the rotor comprising a plurality of rotor laminations and a plurality of magnets, includes providing a cooling sleeve surrounding the rotor hub between the rotor hub and the rotor and flowing coolant from the interior of the rotor hub through the cooling sleeve to between the rotor hub and the rotor during spinning of the rotor hub assembly. In one embodiment, the method includes flowing the coolant through a plurality of channels formed in the inner surface of the cooling sleeve. In one embodiment, the method includes flowing the coolant through an annular channel formed in an outer surface of the rotor hub, the annular channel being in fluid communication with the plurality of channels formed in the inner surface of the cooling sleeve. In one embodiment, the method includes flowing coolant through a plurality of apertures in the annular channel such that interior cavities of the rotor hub are in fluid communication with the channels in the cooling sleeve. In one embodiment, the method includes flowing coolant out of the plurality of channels through a plurality of notches in the rotor hub aligned with the plurality of channels in the cooling sleeve. In one embodiment, the method includes flowing coolant out of the plurality of channels through a plurality of apertures in an end ring attached to a side edge of the rotor hub.

### BRIEF DESCRIPTION OF THE DRAWINGS

FIG. 1A is a perspective view of a first side of a rotor hub assembly according to one embodiment disclosed in this specification.

FIG. 1B is a perspective view of a second side of a rotor hub assembly according to one embodiment disclosed in this specification.

FIG. 2 is an exploded view of a cooling system according to one embodiment disclosed in this specification.

FIG. 3 is a perspective view of a cross section of a rotor hub assembly according to one embodiment disclosed in this specification.

FIG. 4 is a perspective view of a partial cross section of a rotor hub assembly according to one embodiment disclosed in this specification.

FIG. 5 is a perspective view of a partial cross section of a rotor hub assembly according to one embodiment disclosed in this specification.

FIGS. 6A and 6B are a perspective views of a coolant jet and channel in the electric machine casing.

FIG. 7 is a flow diagram of one embodiment of the method disclosed in this specification.

Further features as well as the structure and operation of various embodiments are described in detail below with reference to the accompanying drawings. In the drawings, like reference numbers indicate identical or functionally similar elements.

### DETAILED DESCRIPTION

Components of an electric machine such as, but not limited to, the stator assembly, the rotor assembly, and their respective components, can generate heat energy during the operation of the electric machine. These components can be cooled to enhance the performance and increase the lifespan of the electric machine.

In some embodiments, the electric machine can be an interior permanent magnet electric machine, in which case, the rotor assembly can include a plurality of magnets positioned in a rotor. Also, the electric machine can be, without limitation, an electric motor, such as an induction electric motor, a hybrid motor, an electric generator, or a vehicle alternator. In one embodiment, the electric machine can be an electric motor for use in a traction motor of hybrid vehicle.

In one embodiment, a cooling system provides direct oil cooling as near as possible to the rotor magnets to remove the heat and prevent damage to the magnets. This cooling system minimizes the distance from the source of the heat to the cooling medium and maximizes the surface area available to transfer the heat to the cooling medium.

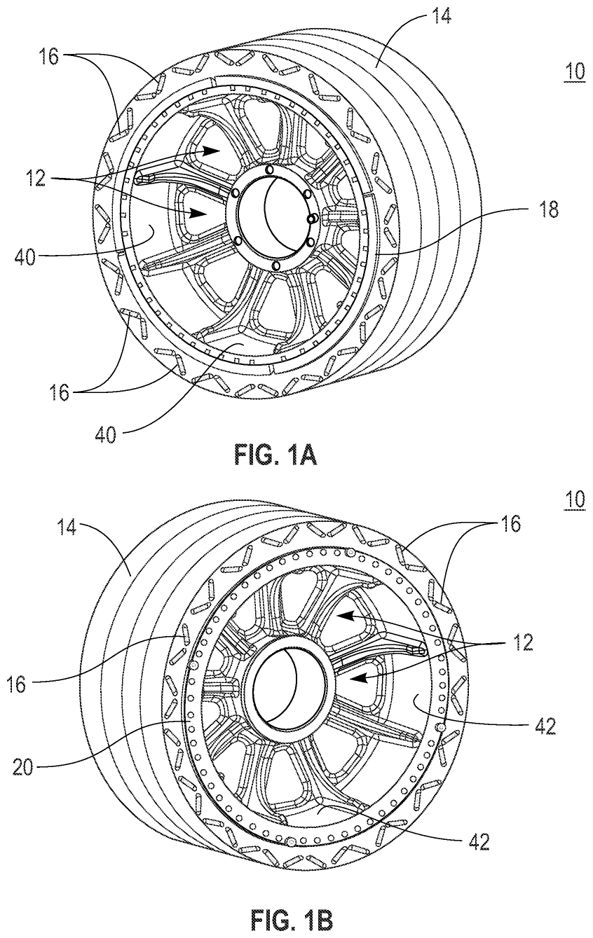

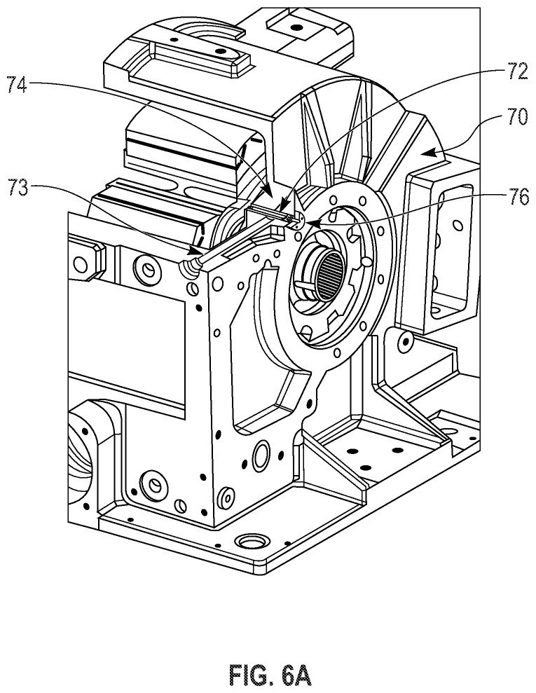

As shown in FIGS. 1A and 1B, a rotor hub assembly 10 includes a rotor hub 12 and rotor laminations 14. FIG. 1A shows a first side of the rotor hub assembly 10 and FIG. 1B shows a second side, opposite to the first side, of the rotor hub assembly 10. A plurality of magnets 16 are located internally within the rotor laminations 14. Magnets 16 extend laterally between the first and second sides as shown in FIG. 5.

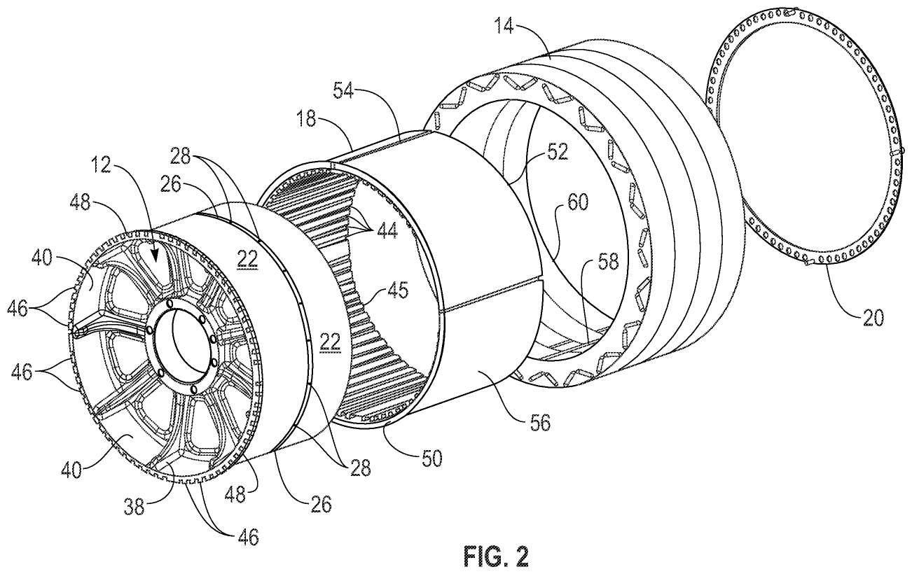

In one embodiment, as best seen in the exploded view of FIG. 2, the rotor hub assembly 10 includes a cooling sleeve 18 located between the rotor hub 12 and the rotor laminations 14. In one embodiment, the cooling sleeve 18 includes an end ring 20 attached to a side edge of the cooling sleeve 18, the purpose of which will be explained below. As shown in the exploded view of FIG. 2, the outer surface 22 of the rotor hub 12 includes an annular channel 26 that surrounds the entire circumference of the outer surface 22 of the rotor hub 12. Within the channel 26 are a plurality of apertures 28 spaced around the outer surface 22 of the rotor hub 12.

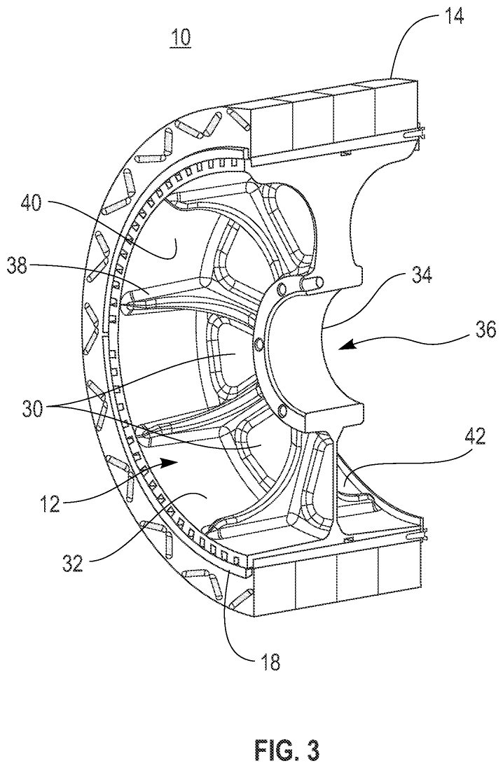

As shown in the cross sectional view of the rotor hub assembly 10 in FIG. 3, the rotor hub 12 has a central plate 30 and a curved outer rim 32 that extends perpendicular to the central plate 30. A curved inner rim 34 forms an opening 36 through which the motor shaft (not shown) extends and is secured to the inner rim 34. As is well known, rotation of the motor shaft causes the rotor hub assembly 10 to rotate. A plurality of splines 38 extend from both the central plate 30 and the outer rim 32 on both sides of the central plate 30. The outer rim 32, inner rim 34, central plate 30 and splines 38 define a plurality of interior cavities 40 on one side of the central plate 30 (see FIG. 1A) and a plurality of interior cavities 42 on the opposite side of the central plate 30 (see FIG. 1B). When the cooling sleeve 18 is assembled onto the rotor hub 12, the annular channel 26 will be located over cavities 42.

Cooling sleeve 18 and includes a plurality of channels 44 formed in the inner surface 45 of the cooling sleeve 18. The channels 44 extend laterally across the inner surface 45 over the entire circumference of inner surface 45 from one side 50 to the opposite side 52 of cooling sleeve 18. When the cooling sleeve 18 is assembled onto the rotor hub 12, each of the channels 44 are in fluid communication with the annular channel 26. In addition, the channels 44 are aligned with notches 46 that are formed on an outer edge of lip 48 of the rotor hub 12. A plurality of keyways 54 are spaced around the circumference of the outer surface 56 of the cooling sleeve 18. The keyways 54 receive ribs 58 spaced around the circumference of the inner surface 60 of the rotor laminations 14.

In one embodiment, the cooling sleeve 18 is fabricated from ductile cast iron. Other materials may be used as appropriate.

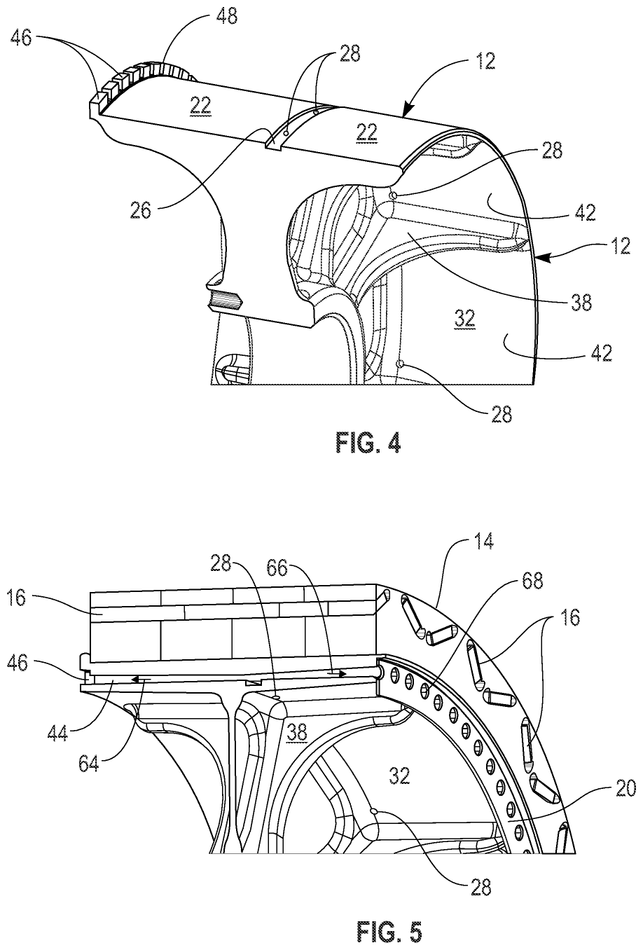

As shown in FIG. 4, the apertures 28 are located within the cavities 42. In one embodiment, at least one aperture 62 is in each cavity 42. In one embodiment, a coolant (not shown) originates from jets in the housing (not shown) of the electric machine of which the rotor hub assembly 10 is a component. In one embodiment, the coolant source can be located internal to the housing. In one embodiment, the coolant can be dispersed from a point generally radially central with respect to the electric machine. In some embodiments, the coolant can comprise a number of substances, including, but not limited to transmission oil, motor oil, oil, or another similar substance.

The coolant in the housing flows inside cavities 40 and 42 of the hub 12 from a coolant source (not shown). As the rotor rotates during operation of the electric machine, the coolant circulates within the cavities 42 and centrifugal force causes the coolant to flow through the apertures 28 in the rotor hub 12 and enter the channel 26. As shown in FIGS. 1B and FIG. 5, the end ring 20 is attached to the side edge of rotor hub 12 having the cavities 42. The end ring 20 acts as a dam to help keep at least a portion of the coolant circulating within the cavities 42 to flow through apertures 28 and enter the channel 26 from the centrifugal force caused by the spinning of rotor hub assembly 10.

As shown FIG. 5, the channels 44 of the cooling sleeve 18 align with notches 46 on the rotor hub 12. The coolant flows from the rotor hub channel 26 into cooling sleeve channels 44 in both the directions of arrows 64 and 66. The coolant flowing in the direction of arrow 64 exits through the notches 46 of the rotor hub 12. The coolant flowing in the direction of arrow 66 exits through apertures 68 in end ring 20.

In one embodiment, the disclosed cooling sleeve provides a cooling system that differs from the known prior art because the cooling system allows the cooling fluid to get closer to the magnets 16 in the rotor laminations 14. In some prior art systems, oil exits the rotor hub on the underside of the hub. In addition, by using a cooling sleeve, coolant is prevented from coming in direct contact with the rotor laminations. The coolant sleeve avoids having to manufacture the rotor laminations with coolant channels as is known in some prior art system, which increases cost. In addition, over time coolant in contact with the rotor laminations can leak through into the air gap increasing motor losses. In cooling system 18, the coolant inside the hub 12 flows through the hub 12 into the cooling sleeve 18 above the hub 12 closer to the magnets 14.

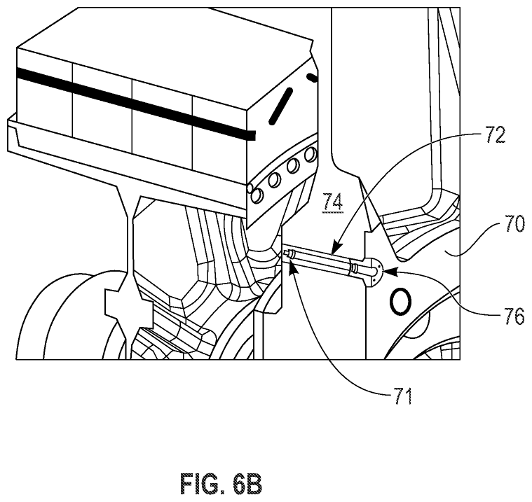

In one embodiment, the coolant to cool the rotor 14 does not jet into the rotor hub 12 from the start. The coolant originates from jets in the electric machine housing which greatly simplifies the coolant system design while still allowing coolant flow to the underside of the active part of the interior permanent magnet motor. As shown in FIGS. 6A and 6B, in one embodiment, an electric machine case 70 includes a channel 72 extending through the casing wall 74. A jet 71 is formed at the end of the channel 72 facing the hub cavities 42. An oil feed passage 73 is located within the wall 74 perpendicular to the channel 72. A stop plug 76 is positioned at the outer end of the channel 72. As the rotor spins, oil enters the channel 72 from the feed passage 73 and is jet through the channel 72 into the cavities 42.

In one embodiment, the channels 44 in the cooling sleeve 18 can fluidly connect with the machine cavity. For example, at least a portion of the coolant that exits outward from the channels 44 can enter the machine cavity. In some embodiments, after flowing through the channels 44, at least a portion of the coolant can axially and radially flow through the machine cavity and can come in contact with, and can receive heat energy from many of the other electric machine components, which can lead to electric machine cooling in addition to cooling of the rotor.

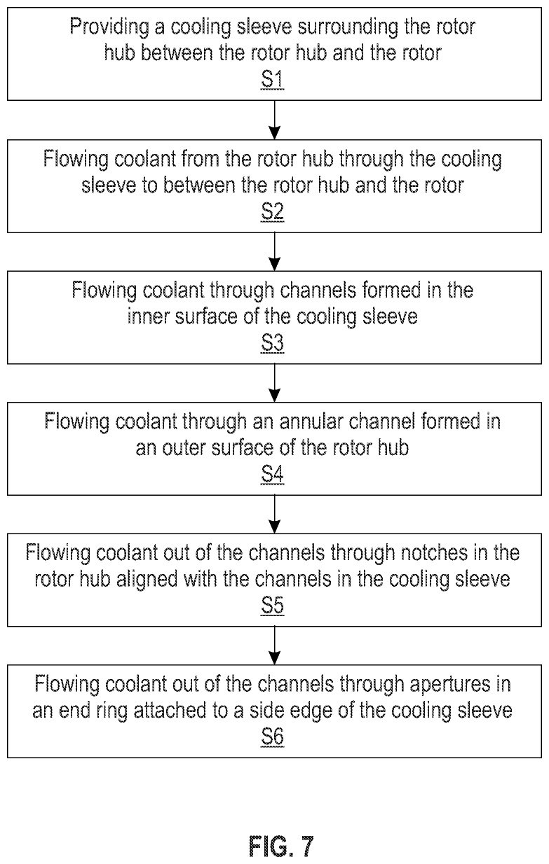

FIG. 7 is a flow chart of one embodiment of a method of cooling a rotor hub assembly including a rotor hub and a rotor surrounding the rotor hub, the rotor comprising a plurality of rotor laminations and a plurality of magnets. In one embodiment, the method includes step S1 of providing a cooling sleeve surrounding the rotor hub between the rotor hub and the rotor and step S2 of flowing coolant from the interior of the rotor hub into the cooling sleeve to distribute between the rotor hub and the rotor during spinning of the rotor hub assembly. In one embodiment, the method includes step S3 of flowing the coolant through a plurality of channels formed in the inner surface of a cooling sleeve. In one embodiment, the method includes step S4 of flowing the coolant through an annular channel formed in the rotor hub, the annular channel being in fluid communication with the plurality of channels formed in the inner surface of the cooling sleeve. In one embodiment, the method includes step S5 of flowing coolant through a plurality of apertures in the annular channel of the rotor hub such that interior cavities of the rotor hub are in fluid communication with the channels of the cooling sleeve. In one embodiment, the method includes step S6 of flowing coolant out of the plurality of channels through a plurality of notches in the rotor hub aligned with the plurality of channels in the cooling sleeve. In one embodiment, the method includes step S6 flowing coolant out of the plurality of channels through a plurality of apertures in an end ring attached to a side edge of the cooling sleeve.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A rotor hub assembly comprising;
a rotor hub;
a rotor surrounding the rotor hub comprising a plurality of rotor laminations and a plurality of magnets; and
a cooling sleeve surrounding the rotor hub and being located between the rotor hub and the rotor, the cooling sleeve being configured to cause coolant to flow between the rotor hub and the rotor during spinning of the rotor hub assembly.

2. The rotor hub assembly of claim 1, wherein the cooling sleeve comprises a plurality of channels formed in the inner surface of the cooling sleeve.

3. The rotor hub assembly of claim 2, wherein the plurality of channels extend laterally across the inner surface from one side to an opposite side of the cooling sleeve.

4. The rotor hub assembly of claim 3, wherein the plurality of channels extend over the entire circumference of the inner surface of the cooling sleeve.

5. The rotor hub assembly of claim 1, wherein the rotor hub comprises an annular channel that surrounds the entire circumference of an outer surface of rotor hub such that the rotor hub annular channel is in fluid communication with the plurality of channels formed in the inner surface of the cooling sleeve.

6. The rotor hub assembly of claim 5, wherein the rotor hub comprises a plurality of apertures within the annular channel.

7. The rotor hub assembly of claim 6, wherein the rotor hub comprises a plurality of interior cavities in fluid communication with the annular channel of the cooling sleeve through the plurality of apertures.

8. The rotor hub assembly of claim 2, further comprising an end ring attached to a side edge of the cooling sleeve, the end ring being configured to cause at least a portion of the coolant circulating within the rotor hub assembly to enter the plurality of channels in the cooling sleeve from centrifugal force caused by spinning of the rotor hub assembly.

9. The rotor hub assembly of claim 5, further comprising an end ring attached to a side edge of the cooling sleeve, the end ring being configured to cause at least a portion of the coolant circulating within the rotor hub assembly to enter the annular channel from centrifugal force caused by spinning of the rotor hub assembly.

10. The rotor hub assembly of claim 2, wherein the rotor hub comprises a plurality of notches aligned with the plurality of channels in the cooling sleeve such that coolant entering the plurality of channels in the cooling sleeve exits through the notches.

11. The rotor hub assembly of claim 8, wherein the end ring comprises a plurality of apertures aligned with the plurality of channels in the cooling sleeve such that coolant entering the plurality of channels in the cooling sleeve exits through the plurality of apertures in the end ring.

12. The rotor hub assembly of claim 1, further including a channel extending through a casing in which the rotor hub assembly is mounted and a coolant jet positioned at the outer end of the casing channel.

13. A method of cooling a rotor hub assembly comprising a rotor hub and a rotor surrounding the rotor hub, the rotor comprising a plurality of rotor laminations and a plurality of magnets, the method comprising:
providing a cooling sleeve surrounding the rotor hub between the rotor hub and the rotor; and
flowing coolant from the interior of the rotor hub into the cooling sleeve to distribute coolant between the rotor hub and the rotor during spinning of the rotor hub assembly.

14. The method of claim 13, comprising flowing the coolant through a plurality of channels formed in the inner surface of the cooling sleeve.

15. The method of claim 14, comprising flowing the coolant through an annular channel formed in an outer surface of the rotor hub, the annular channel being in fluid communication with the plurality of channels formed in the inner surface of the cooling sleeve.

16. The method of claim 15, comprising flowing coolant through a plurality of apertures in the annular channel the rotor hub such that interior cavities of the rotor hub are in fluid communication with the channels in the cooling sleeve.

17. The method of claim 16, comprising flowing coolant out of the plurality of channels through a plurality of notches in the rotor hub aligned with the plurality of channels in the cooling sleeve

18. The method of claim 17, comprising flowing coolant out of the plurality of channels through a plurality of apertures in an end ring attached to a side edge of the cooling sleeve.

19. The method of claim 13, further including jetting coolant through a coolant jet positioned at the outer end of a casing channel extending through a casing in which the rotor hub assembly is mounted.
